(19) United States
(12) Patent Application Publication
(10) Pub. No.: US 2026/0270848 A1
(43) Pub. Date: Sep. 10, 2026

(54) COMMUNICATION METHODS AND UE

(71) Applicant: BEIJING XIAOMI MOBILE SOFTWARE CO., LTD., Beijing (CN)

(72) Inventor: Jianning LIU, Beijing (CN)

(21) Appl. No.: 19/153,569

(22) PCT Filed: Feb. 10, 2023
(86) PCT No.: PCT/CN2023/075542

§ 371 Date: Aug. 4, 2025

(51) Int. Cl. H04W 48/08; H04W 60/00; H04W 84/18

(52) U.S. Cl. CPC H04W 48/08; H04W 60/00; H04W 84/18

(57) ABSTRACT

A communication method performed by a user equipment (UE) includes: receiving personal Internet-of-Things network (PIN) policy information.

### CROSS-REFERENCE TO RELATED APPLICATION

This application is the U.S. National Stage Application of International Application No. PCT/CN2023/075542, filed on Feb. 10, 2023, the entire content of which is incorporated herein by reference.

### TECHNICAL FIELD

The disclosure relates to the field of wireless communication technology, and in particular to a communication method, a communication apparatus and a readable storage medium.

### BACKGROUND

A Personal IoT Network (PIN) contains PIN Elements that communicate using PIN Direct Connection or direct network connection and is managed locally using a PIN Element with Management Capability (PEMC).

### SUMMARY

According to a first aspect of the disclosure, a communication method is provided. The method is performed by a user equipment (UE), including: receiving personal IoT network (PIN) policy information.

According to a second aspect of the disclosure, a communication method is provided. The method is performed by a PCF, including: sending PIN policy information.

According to a third aspect of the disclosure, a communication method is provided, which is performed by an AMF, including: receiving PIN policy information sent by a PCF; and sending the PIN policy information to a UE.

### BRIEF DESCRIPTION OF THE DRAWINGS

The drawings described herein are used to provide further understanding of the embodiments of the disclosure and constitute a part of the disclosure. The embodiments of the disclosure and their descriptions are used to explain the embodiments of the disclosure and do not constitute improper limitations on the embodiments of the disclosure.

FIG. 1 is a schematic diagram illustrating an architecture of a wireless communication system according to an embodiment of the disclosure.

FIG. 2 is a flowchart illustrating a communication method according to an embodiment.

FIG. 3 is a flowchart illustrating another communication method according to an embodiment.

FIG. 4 is a flowchart illustrating another communication method according to an embodiment.

FIG. 5 is a flowchart illustrating a communication method according to another embodiment.

FIG. 6 is a flowchart illustrating a communication method according to another embodiment.

FIG. 7 is a flowchart illustrating a communication method according to another embodiment.

FIG. 8 is a flowchart illustrating a communication method according to another embodiment.

FIG. 9 is a flowchart illustrating a communication method according to another embodiment.

FIG. 10 is a flowchart illustrating a communication method according to another embodiment.

FIG. 11 is an interaction diagram illustrating a communication method according to an embodiment.

FIG. 12 is a block diagram illustrating a communication apparatus according to an embodiment.

FIG. 13 is a block diagram illustrating a UE according to an embodiment.

FIG. 14 is a block diagram illustrating a communication apparatus according to an embodiment.

FIG. 15 is a block diagram illustrating a communication apparatus according to another embodiment.

### DETAILED DESCRIPTION

The embodiments of the disclosure are now further described in conjunction with the accompanying drawings and detailed description.

Reference will now be made in detail to embodiments, examples of which are illustrated in the accompanying drawings. When the following description refers to the drawings, unless otherwise indicated, the same numbers in different drawings represent the same or similar elements. The implementations described in the following embodiments do not represent all implementations consistent with the embodiments of the disclosure. Rather, they are merely examples of apparatuses and methods consistent with some aspects of the disclosure as recited in the appended claims.

The terms in the embodiments of the disclosure are used for the purpose of describing specific embodiments only and are not intended to limit the embodiments of the disclosure. As used in the embodiment of the disclosures and the appended claims, the singular forms “a/an” and “the” are intended to include the plural forms as well, unless the context clearly indicates otherwise. It should also be understood that the term “and/or” used herein refers to and encompasses any and all possible combinations of one or more of the associated listed items.

It should be understood that although the terms first, second, third, etc. may be used to describe various information in the embodiments of the disclosure, the information should not be limited to these terms. These terms are used only to distinguish information of the same type from one another. For example, without departing from the scope of the embodiments of the disclosure, the first information may also be referred to as the second information, and similarly, the second information may also be referred to as the first information. Depending on the context, the words “if” and “in case that” as used herein may be interpreted as “when” or “while” or “in response to determining . . . ”.

Embodiments of the disclosure are described in detail below, examples of which are illustrated in the accompanying drawings, throughout which the same or similar reference numerals refer to the same or similar elements. The embodiments described below with reference to the accompanying drawings are exemplary and are intended to be used to explain the disclosure, but cannot be understood as a limitation to the disclosure.

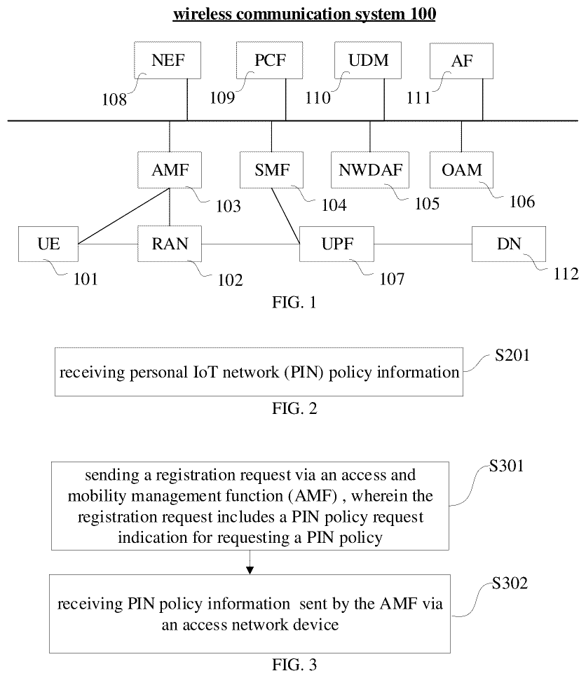

FIG. 1 illustrates a wireless communication system 100, which is a schematic diagram of a network architecture applicable to the embodiments of the disclosure.

It is taken as an example that the network architecture is applied to the 5th-generation (5G) mobile communication technology, as shown in FIG. 1, the wireless communication system 100 includes: a UE 101, a radio access network (RAN) 102 and a core network (5GC).

The UE 101 may be a terminal, an access terminal, a terminal unit, a terminal station, a mobile station (MS), a remote station, a remote terminal, a mobile terminal, a wireless communication device, a terminal agent or a terminal device, etc. The UE 101 may have a wireless transceiver function, may perform communication (such as wireless communication) with one or more RAN devices 102 in one or more communication systems, and receive network services provided by the RAN devices 102. The UE 101 may be a cellular phone, a cordless phone, a session initiation protocol (SIP) phone, a wireless local loop (WLL) station, a personal digital assistant (PDA) device, a handheld device with the wireless communication function, a computing device or other processing device connected to a wireless modem, a vehicle-mounted device, a wearable device, a terminal in a future 5G network or a future evolved public land mobile network (PLMN) network, etc.

The RAN 102 refers to a device that provides network access functions. The RAN 102 may specifically include a base station (BS), or a BS and a radio resource management device for controlling the BS. The RAN 102 may also include a relay station (a relay device), an access point, a BS in the future 5G network, a BS in the future evolved PLMN network, or a new radio (NR) BS, etc. The network device 102 may be a wearable device or a vehicle-mounted device. The RAN 102 may also be a communication chip having a communication module. For example, the RAN 102 includes but is not limited to: a next generation node B (gNB) in the 5G, an evolved node B (eNB) in the LTE system, a radio network controller (RNC), a node B (NB) in a Wideband Code Division Multiple Access (WCDMA) system, a wireless controller in a Centralized RAN (CRAN) system, a base station controller (BSC), a base transceiver station (BTS) in a Global System for Mobile Communications (GSM) system or a Code Division Multiple Access System (CDMA) system, a home base station (for example, home evolved nodeB, or home node B, HNB), a baseband unit (BBU), a transmitting and receiving point (TRP), a transmitting point (TP) or a mobile switching center, etc.

In the wireless communication system 100, the UE 101 may access a data network (DN) 112 via the RAN 102 to obtain services. The UE exchanges information with the RAN 102 via a radio interface, and RAN 102 is responsible for scheduling radio interface resources for the UE 101 to access the network and managing radio interface connections. The DN 112 is a service network that provides users with data transmission services, such as operator services, Internet access, and third-party services.

The core network 5GC may include the following network elements: an access and mobility management function (AMF) 103, a session management function (SMF) 104, a network data analytics function (NWDAF) 105, an operation administration and maintenance (OAM) 106, a user plane function (UPF) 107, a network exposure function (NEF) 108, a policy and charging function (PCF) 109, a unified data management function (UDM) 110, and an application function (AF) 111, etc.

The AMF 103 is a network element on a core network control plane, which is used to implement user registration management, connection management, mobility management and user accessibility management, and participate in control plane management functions such as authentication and authorization-related management.

The SMF 104 is a network element on the core network control plane, which is mainly responsible for session management related works, including establishment, modification, and release. The NWDAF 105 is a network element introduced in 5G and is mainly used for analyzing various types of network data.

The NWDAF105 may collect network operation data from a network function (NF) on the core network control plane, obtain statistical data related to the UE 101 and the network from the OAM 106, and obtain application data from the AF 111.

The NWDAF105 may feed back analysis results to the NF, the OAM 106 or the AF 111 within a certain analysis delay.

The OAM106 is mainly responsible for operation, management and maintenance of network operations of operators. The operation mainly involves analyzing, forecasting, planning, and configuring of daily networks and services. The maintenance mainly involves daily operational activities such as testing and fault management of the network and its services.

The UPF 107 is mainly responsible for routing and forwarding functions on the user plane.

The NEF 108 is a network element on the core network control plane, which is mainly responsible for exposing mobile network capabilities to the outside world and converting internal and external information.

The PCF 109 is a network element on the core network control plane, which is mainly used to obtain policy information subscribed by a user terminal and send the policy information to an AMF device and an SMF device.

The UDM 110 is a network element on the core network control plane, which is mainly responsible for unified processing of front-end data, including a user identifier (ID), user subscribed data, authentication data, etc.

The AF 111 interacts with the 5G core network to provide services, support applications to affect traffic routing, access the NEF, interact with the policy architecture, etc.

It needs to be noted that the above-mentioned architecture is only used to illustrate the scenarios to which the embodiments of the disclosure are applicable. The types of network elements therein are only for illustration and do not limit the architecture to include the illustrated network elements. The names of the network elements are also only used to refer to network elements in the 5G core network with corresponding functions, and other names may also be used. A connection relationship between various communication devices or network elements is only an example. In a specific implementation, the names of the communication devices or network elements and the connection relationship between various communication devices or network elements may be embodied in other forms, which is no limited in the disclosure.

In order to support necessary procedures in a Personal IoT Network (PIN) communication process, such as communication between PIN Elements (PINEs), discovery and authorization for a PINE, discovery and authorization for a PIN Element with Gateway Capability (PEGC), or discovery and authorization for a PEMC, a necessary PIN policy or parameter configuration is required.

In view of the above, an embodiment of the disclosure provides a communication method, which is performed by the UE 101. Referring to FIG. 2, it is a flowchart illustrating a communication method according to an embodiment. The method shown in FIG. 2 is performed by a UE 101. As shown in FIG. 2, the method includes the following step S201.

At S201, a UE 101 receives PIN policy information.

In some possible implementations, the PIN policy information may be used to support the necessary procedures regarding to the PIN, such as communication between PINEs, discovery and authorization for the PINE, discovery and authorization for the PEGC, or discovery and authorization for the PEMC.

In some possible implementations, the PIN policy information includes at least one of: a PIN ID, a configuration of a PEGC, or routing information.

In the embodiment of the disclosure, after obtaining the PIN policy information, the UE 101 may support the necessary procedures for the PIN, such as communication between PINEs, discovery and authorization for the PINE, discovery and authorization for the PEGC, or discovery and authorization for the PEMC, which thus overcomes the problem of being unable to support the necessary procedures for the PIN since the UE 101 does not obtain PIN-related policy information.

An embodiment of the disclosure provides a communication method, which is performed by the UE 101. The method includes the following steps S201-1 to S201-2.

At S201-1, the UE 101 sends a PIN policy request indication.

In some possible implementations, the PIN policy request indication is used to request the PIN-related policy information during a registration process.

In some possible implementations, the UE 101 may send the PIN policy request indication in different ways. For example, the PIN policy request indication is sent in a different message.

In an example, step S201-1 may be implemented by the following step S201-11, for example:

At S201-11, the UE 101 sends a registration request, in which the registration request includes the PIN policy request indication.

In the example, during the registration process of the UE 101, the PIN policy request indication is introduced in the registration request.

In other examples, the UE 101 may also introduce the PIN policy request indication in other interaction messages. For example, the UE 101 sends an uplink request message or an indication message including the PIN policy request indication to the RNA 102, and sends other messages carrying the PIN policy request indication to the 5GC network element via the RNA 102.

In some possible implementations, even if the message carrying the PIN policy request indication is determined as a registration request, there may be a plurality of ways to send the PIN policy request indication. For example, the step S201-11 may be still used in the step S201-1 in the method, that is, the PIN policy request indication may be sent by sending a registration request. The registration request includes the PIN policy request indication. It may be understood that the inclusion here may be either a direct inclusion or an implicit indication.

In an example, the PIN policy request indication may correspond to one or more set bits in the registration request. For example, when a value of one or more set bits is equal to a first value, it indicates that the registration request includes the PIN policy request indication.

In another example, the registration request includes a first UE policy container including the PIN policy request indication.

It may be understood that the “first” here is only for clarity of expression and does not limit the UE policy container. For example, the first UE policy container and the second UE policy container as described below may be an identical carrier for UE policy container information, but the contents of the two UE policy containers under the two definitions are different.

In some possible implementations, the step S201-1 may also be implemented by the following step S201-12, for example.

At S201-12, the UE 101 sends a first UE policy container, in which the first UE policy container includes the PIN policy request indication.

In this implementation, the UE 101 may send the first UE policy container via the registration request, other messages, or other carriers, which is not limited in the embodiment.

At S201-2, the UE 101 receives PIN policy information.

In some possible implementations, the PIN policy information may be used to support necessary procedures for the PIN, such as communication between PINEs.

In the embodiment of the disclosure, the UE 101 may actively request the PIN policy information by sending the PIN policy request indication, and may perform PIN-related procedures after obtaining the PIN policy information, which thus overcomes the problem of being unable to support the necessary procedures for the PIN since the UE 101 does not obtain the PIN-related policy information.

An embodiment of the disclosure provides a communication method, which is performed by the UE 101. The method includes the following steps S201-1′ to S201-2.

At S201-1′, the UE 101 sends a PIN policy request indication to the AMF 103.

In some possible implementations, the UE 101 may send the PIN policy request indication to the AMF 103 directly or indirectly. For example, the UE 101 sends the PIN policy request indication to the AMF 103 via the RAN 102.

In an example, the UE 101 sends the registration request to the AMF 103 via the RAN 102, in which the registration request includes the PIN policy request indication.

In another example, the UE 101 sends the registration request to the AMF 103 via the RAN 102, in which the registration request includes a first UE policy container including the PIN policy request indication.

In another example, the UE 101 sends the first UE policy container to the AMF 103 via the RAN 102, in which the first UE policy container includes the PIN policy request indication.

At S201-2, the UE 101 receives PIN policy information.

The implementation of this step may refer to the description of the above embodiment, which is not fully repeated here.

In some possible implementations, the UE 101 may receive the PIN policy information sent by the AMF 103, for example, the AMF 103 sends the PIN policy information to the UE 101 via the RAN 102.

In the embodiment of the disclosure, the UE 101 may send the PIN policy request indication to the AMF 103 in a variety of ways to obtain the requested PIN policy information.

An embodiment of the disclosure provides a communication method, which is performed by the UE 101. The method includes the following steps S201-1″ to S201-2.

At S201-1″, the UE 101 sends the PIN policy request indication to the PCF 109 via the AMF 103.

In some possible implementations, the PCF 109 may be pre-configured with the PIN policy information.

In some possible implementations, the UE 101 may directly or indirectly send the PIN policy request indication to the AMF 103, and the AMF 103 sends the received PIN policy request indication to the PCF 109. For example, the UE 101 sends the PIN policy request indication to the AMF 103 via the RAN 102, and the AMF 103 sends the PIN policy request indication to the PCF 109.

In an example, the UE 101 sends the registration request to the AMF 103 via the RAN 102, in which the registration request includes the PIN policy request indication. The AMF 103 sends a message carrying the PIN policy request indication to the PCF 109.

In another example, the UE 101 sends the registration request to the AMF 103 via the RAN 102, in which the registration request includes a first UE policy container including the PIN policy request indication. The AMF 103 sends a message carrying the first UE policy container to the PCF 109.

In another example, the UE 101 sends the first UE policy container to the AMF 103 via the RAN 102, in which the first UE policy container includes the PIN policy request indication. The AMF 103 sends a message carrying the first UE policy container to the PCF 109.

At S201-2, the UE 101 receives PIN policy information.

The implementation of this step may refer to the description of the above embodiment, which is not repeated here.

In the embodiment of the disclosure, the UE 101 may send the PIN policy request indication to the AMF 103 in a variety of ways, and request the PIN policy information from the PCF 109 via the AMF 103 to obtain the requested PIN policy information.

An embodiment of the disclosure provides a communication method, which is performed by the UE 101. The method includes the following step S201′.

At S201′, the UE 101 receives a second UE policy container, in which the second UE policy container includes the PIN policy information.

In some possible implementations, the UE 101 may receive a message carrying the second UE policy container to obtain the second UE policy container and learn the PIN policy information from the second UE policy container.

In an example, the following step S201″ may be used in the step S201′.

At S201″, the UE 101 receives the second policy container sent by the AMF 103

Alternatively, the step S201″ is that the UE 101 receives the second policy container sent by the PCF 109 via the AMF 103.

In some possible implementations, the PCF 109 may send a message carrying a second measurement container to the AMF 103, and the AMF 103 transfers transparently the second measurement container to the UE 101. For example, the AMF 103 sends the second policy container to the UE 101 via the RAN 102.

The embodiment of the disclosures provide a method or a manner for the UE 101 to obtain PIN-related policy information during the registration process. For example, it includes the following two aspects: firstly, how the UE 101 requests the PIN-related policy information; and secondly, how the core network provides the PIN-related policy information to the UE 101 so that the UE 101 may implement PIN-related procedures.

An embodiment of the disclosure provides a communication method, which is performed by the UE 101. The method includes the following steps S200-S201.

At S200, before receiving the PIN policy information, the UE 101 receives a registration accept message, in which the registration accept message indicates that the UE has successfully registered with a network.

In some possible implementations, the UE 101 may send the registration request to the AMF 103, and the AMF 103 may send the registration accept message to the UE 101.

In some possible implementations, the UE 101 sends the PIN policy request indication in the registration request, so as to request the PIN policy information.

At S201, the UE 101 receives PIN policy information.

The implementation of this step may refer to the description of the above embodiment, which is not repeated here.

In the embodiment of the disclosure, a reference timing that the UE 101 sends the PIN policy request indication and receives the PIN policy information during the registration process is described, which provides a reference for obtaining a PIN policy or performing PIN communication using the PIN policy information.

An embodiment of the disclosure provides a communication method, which is performed by the UE 101. The method includes the following steps S201-S202.

At S201, the UE 101 receives PIN policy information.

The implementation of this step may refer to the description of the above embodiment, which is not repeated here.

In some possible implementations, the PIN policy information includes at least one of: a PIN ID, a configuration of a PEGC, or routing information.

At S202, after receiving the PIN policy information, the UE 101 sends a notification message.

In some possible implementations, after receiving the PIN policy information, the UE 101 may update or store the PIN policy information locally, and send the notification message after the update or storage is completed.

In some possible implementations, the UE 101 may send the notification message to the PCF 109 via the AMF 103 to inform that the PIN policy information has been received.

In the embodiment of the disclosure, after obtaining the PIN policy information, the UE 101 may update the PIN policy information locally in a timely manner, so as to perform PIN communication or implement PIN-related programs according to the PIN policy information. In addition, after the update is completed, the UE 101 may also feedback an update result to the PCF 109 via the AMF 103 in a timely manner.

To facilitate understanding of the method performed by the UE 101 in the embodiment of the disclosure, the following embodiment describes an implementation in which the UE 101 requests the PIN policy information via the RAN 102.

An embodiment of the disclosure provides a communication method, which is performed by the UE 101. Referring to FIG. 3, it is a flowchart illustrating a communication method according to an embodiment. The method shown in FIG. 3 is performed by a UE 101. As shown in FIG. 3, the method includes the steps S301 to S302.

At S301, a UE 101 sends a registration request to an AMF 103 via an access network device 102, in which the registration request includes a PIN policy request indication for requesting a PIN policy.

In some possible implementations, referring to the architecture shown in FIG. 1, the UE 101 may communicate with a network element of the core network, such as the AMF 103, via the access network device 102.

In some possible implementations, the UE 101 sends the registration request for requesting to register with the network. In the embodiment of the disclosure, the PIN policy request indication is introduced into the registration request, so as to request the PIN-related policy information during the registration process.

In some possible implementations, the PIN may be a network formed by different devices of the same user, for example, the PIN includes PIN elements such as the UE 101, other wearable devices, and smart home/smart office devices. That is, the UE 101 is a PIN element in the PIN.

In an example, one PIN includes at least one PEGC, and at least one PEMC. Via the PEGC, PIN Elements have access to the 5G network services and may communicate with PIN Elements that are not within range to use PIN Direct Connection.

For example, the UE 101 may serve as the PEGC.

In some possible implementations, there may be a plurality of implementations that the PIN policy request indication is included in the registration request. For example, the PIN policy request indication may be sent in the registration request in the form of a bit indication. For example, when a bit is set as a first value, it indicates that the PIN policy request indication is included in the registration request.

At S302, the UE 101 receives the PIN policy information sent by the AMF 103 via the access network device 102.

In some possible implementations, the AMF 103 sends to the PCF 109, the PIN policy request indication from the UE 101, receives the PIN policy information sent by the PCF 109, and sends the received PIN policy information to the UE 101. For example, the AMF 103 transfers transparently the PIN policy information received from the PCF 109 to the UE 101.

In some possible implementations, if the UE 101 does not obtain the PIN-related policy information, the necessary procedures for the PIN cannot be supported, such as communication between PINEs, discovery and authorization for the PINE, discovery and authorization for the PEGC, or discovery and authorization for the PEMC.

Therefore, the embodiments of the disclosure provide a method or a manner for the UE 101 to obtain the PIN-related policy information during the registration process. For example, it includes the following two aspects: firstly, how the UE 101 requests the PIN-related policy information; and secondly, how the core network provides the PIN-related policy information to the UE 101 so that the UE 101 may implement PIN-related procedures.

In the embodiment of the disclosure, the UE 101 sends the registration request to the AMF 103 via the access network device 102, and introduces the PIN policy request indication to synchronously request a PIN policy during the registration process. The AMF 103 may request the PIN policy from the PCF 109, and send the PIN policy to the UE 101 via the access network device 102, so as to support communication needs of the UE 101 in the PIN scenarios.

An embodiment of the disclosure provides a communication method, which is performed by the UE 101. The method includes steps S301 to S302.

At S301, a UE 101 sends a registration request to an AMF 103 via an access network device 102, in which the registration request includes a PIN policy request indication for requesting a PIN policy.

At S302, the UE 101 receives the PIN policy information sent by the AMF 103 via the access network device 102.

In the embodiment, the registration request includes a UE policy container including the PIN policy request indication.

The implementation of the above steps S301 and S302 may refer to the description of the embodiment corresponding to FIG. 3, which will not be repeated here.

In some possible implementations, the content of the registration request includes the UE policy container, and the UE policy container includes the PIN policy request indication. For example, the PIN policy request indication may be a new indication introduced in the UE policy container, or may be indicated by a policy section identity (PSI) in the UE policy container. It may be understood that the UE policy container may also adopt other similar policy containers defined or described in the protocol.

In some possible implementations, the AMF 103 may send the UE policy container including the PIN policy request indication to the PCF 109.

In the embodiment of the disclosure, the PIN policy request indication is introduced into the UE policy container sent by the UE 101 to the AMF, so as to support the UE 101 to request the PIN-related policy information during the registration process.

An embodiment of the disclosure provides a communication method, which is performed by the UE 101. The method includes the following steps S301 to S302′.

At S301, a UE 101 sends a registration request to an AMF 103 via an access network device 102, in which the registration request includes a PIN policy request indication for requesting a PIN policy.

The implementation of the above step S301 may refer to the description of the embodiment corresponding to FIG. 3, which will not be repeated here.

At S302′, the UE 101 receives a UE policy container sent by the AMF 103 via the access network device 102, in which the UE policy container includes the PIN policy information.

In some possible implementations, the AMF 103 forwards the UE policy container including the PIN policy information received from the PCF 109 to the UE 101. The UE policy container including the PIN policy information and the above UE policy container including the PIN policy request indication have a same information carrier but different information content.

In the embodiment of the disclosure, the UE 101 sends the UE policy container including the PIN policy request indication to the PCF 109 via the RAN 102 and the AMF 103, so as to request the PIN-related policy information during the registration process. The PCF 109 sends the UE policy container including the PIN policy information to the UE 101 via the AMF 103 and the RAN 102, so that the UE 101 may implement the PIN-related procedures. Therefore, the embodiment of the disclosure provides a method for the UE 101 to obtain the PIN-related policy information during the registration process, which may overcome the related defects caused by the UE 101 being unable to obtain the PIN policy.

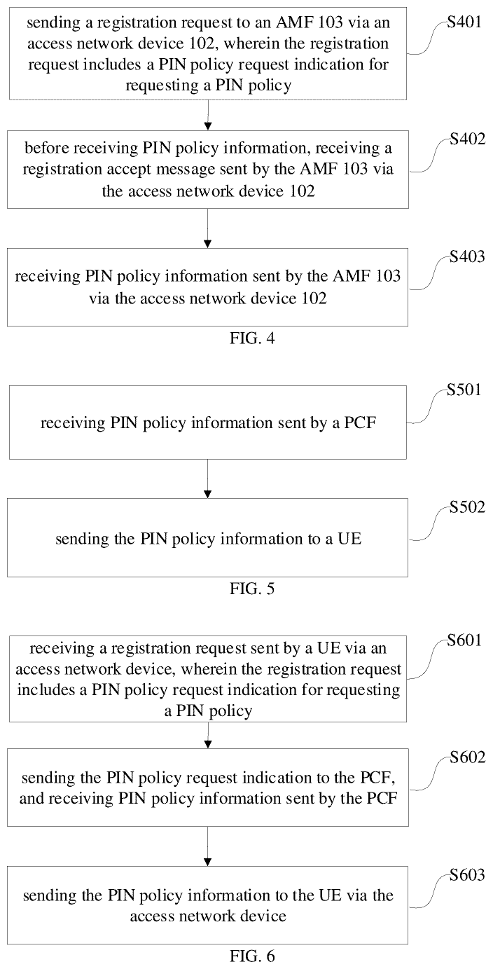

An embodiment of the disclosure provides a communication method, which is performed by the UE 101. Referring to FIG. 4, it is a flowchart illustrating a communication method according to an embodiment. The method shown in FIG. 4 is performed by a UE 101. As shown in FIG. 4, the method includes steps S401 to S403.

At S401, a UE 101 sends a registration request to an AMF 103 via an access network device 102, in which the registration request includes a PIN policy request indication for requesting a PIN policy.

At S402, before receiving PIN policy information, the UE 101 receives a registration accept message sent by the AMF 103 via the access network device 102, in which the registration accept message indicates that the UE 101 has successfully registered with a network.

In some possible implementations, after the registration accept message is obtained, it indicates that the UE 101 has successfully registered, but the UE 101 may not have received the PIN policy information.

At S403, the UE 101 receives PIN policy information sent by the AMF 103 via the access network device 102.

It may be understood that the implementation of the above step S401 may refer to the description of the above step S301 in the above embodiments, and the implementation of the above step S403 may refer to the description of the above step S302 in the above embodiments, which will not be repeated here.

In some possible implementations, when the step S302 may include for example the step S302′, the implementation of the above step S403 may also refer to the implementation of the above step S302′.

In the embodiment of the disclosure, a reference timing that the UE 101 sends the PIN policy request indication and receives the PIN policy information during the registration process is described, which provides a reference for obtaining a PIN policy or performing PIN communication using the PIN policy information.

An embodiment of the disclosure provides a communication method, which is performed by the UE 101. The method includes the following steps S401 to S404.

At S401, a UE 101 sends a registration request to an AMF 103 via an access network device 102, in which the registration request includes a PIN policy request indication for requesting a PIN policy.

At S402, before receiving PIN policy information, the UE 101 receives a registration accept message sent by the AMF 103 via the access network device 102, in which the registration accept message indicates that the UE 101 has successfully registered with a network.

At S403, the UE 101 receives PIN policy information sent by the AMF 103 via the access network device 102.

The implementation of the above steps S401 to S403 may refer to the description of the above embodiments, which will not be repeated here.

At S404, after updating the PIN policy information, the UE 101 sends a notification message to the AMF 103 via the access network device 102.

In some possible implementations, after receiving the UE policy container including the PIN policy information, the UE 101 updates the PIN policy information locally, such as storing or configuring the PIN policy information locally, to complete the update of the PIN policy information. After completing the update, the UE 101 may send the corresponding result to the AMF 103 to report the completion of the update.

In other words, when the UE 101 has sent the notification message, or the AMF 103 has received the notification message, it is considered that updating the PIN policy information of the UE 101 is completed.

In some possible implementations, the PIN policy information includes at least one of: a PIN ID, a configuration of a PEGC, or routing information.

In an example, the PIN ID is used to identify one PIN. Referring to the description of the above embodiments, the PIN may include a plurality of PIN elements, such as the UE 101 serving as a PEGC.

In an example, the configuration of PEGC indicates information of a PIN element that may be used as the PEGC.

In an example, the routing information indicates routing information corresponding to the PIN.

In the embodiment of the disclosure, after obtaining the PIN policy information, the UE 101 may update the PIN policy information locally in a timely manner, so as to perform PIN communication or implement PIN-related programs according to the PIN policy information. In addition, after the update is completed, the UE 101 may also feedback an update result to the PCF 109 via the AMF 103 in a timely manner.

An embodiment of the disclosure provides a communication method, which is performed by the AMF 103. Referring to FIG. 5, it is a flowchart illustrating a communication method according to an embodiment. The method shown in FIG. 5 is performed by an AMF 103. As shown in FIG. 5, the method includes the following steps S501 to S502.

At S501, an AMF 103 receives PIN policy information sent by a PCF 109.

In some possible implementations, the PCF 109 is pre-configured with the PIN policy information.

At S502, the AMF 103 sends the PIN policy information to a UE 101.

In some possible implementations, the AMF 103 may send the PIN policy information directly to the UE 101, or the AMF 103 may send the PIN policy information to the UE 101 via the RAN 102.

In the embodiment of the disclosure, the AMF 103 may forward the PIN policy information received from the PCF 109 to the UE 101, so as to meet communication needs of the UE 101 in the PIN scenarios.

An embodiment of the disclosure provides a communication method, which is performed by the AMF 103. The method includes the following steps S501′ to S502.

At S501′, the AMF 103 receives a second UE policy container sent by the PCF 109, in which the second UE policy container includes the PIN policy information.

At S502, the AMF 103 sends the PIN policy information to the UE 101.

In the embodiment of the disclosure, the AMF 103 may receive a second UE policy container including the PIN policy information sent by the PCF 109, and forward the second UE policy container to the UE 101, so as to implement sending the PIN policy information.

An embodiment of the disclosure provides a communication method, which is performed by the AMF 103. The method includes the following steps S500 to S502.

At S500, the AMF 103 receives the PIN policy request indication sent by the UE 101, and sends the PIN policy request indication to the PCF 109.

In some possible implementations, the AMF 103 may receive the PIN policy request indication sent by the UE 101 via the RAN 102.

In an example, receiving by the AMF 103, the PIN policy request indication sent by the UE 101 at S500, may include the following step S500′, for example.

At S500′, the AMF 103 receives a registration request sent by the UE 101, in which the registration request includes a first UE policy container including the PIN policy request indication.

For example, the AMF 103 receives the registration request sent by the UE 101 via the RAN 102, in which the registration request includes the first UE container including the PIN policy request indication. The other ways may refer to the description of the embodiment corresponding to FIG. 2.

In another example, sending by the AMF 103, the PIN policy request indication to the PCF 109 at S500 may include the following step S500″, for example.

At S500″, the AMF 103 sends a create request to the PCF 109, in which the create request includes the PIN policy request indication.

In this example, the create request may include a first UE policy container in some implementations, which thus implements forwarding the PIN policy request indication.

In some possible implementations, after step S500″, the method further includes step S50, for example.

At S50, the AMF 103 receives a response message sent by the PCF 109, in which the response message indicates a success or failure of UE policy control creating.

In an example, the response information may indicate whether UE policy control creating is successful or fails, that is, whether UE policy association establishment is successful or fails. When the UE policy association establishment is successful, a UE policy association ID may be included in the response message to index the associated PIN policy information.

At S501, the AMF 103 receives the PIN policy information sent by the PCF 109

At S502, the AMF 103 sends the PIN policy information to the UE 101.

The implementation of the above steps S501 and S502 may refer to the description of the above embodiments, which will not be repeated here.

In the embodiment of the disclosure, after receiving the registration request from the UE 101, the AMF 103 may send the PIN policy request indication sent by the UE 101 to the PCF 109, so as to request the PIN policy from the PCF 109.

An embodiment of the disclosure provides a communication method, which is performed by the AMF 103. The method includes the following steps S501 to S503.

At S501, the AMF 103 receives the PIN policy information sent by the PCF 109.

At S502, the AMF 103 sends the PIN policy information to the UE 101.

At S503, the AMF 103 receives a notification message sent by the UE 101, and sends the notification message to the PCF 109, in which the notification message indicates that the UE 101 has received the PIN policy information.

In some possible implementations, the UE 101 may send the notification message to the AMF 103 via the RAN 102.

In the embodiment of the disclosure, after receiving the PIN policy information (such as after synchronizing the PIN policy information), the UE 101 may report the notification message in a timely manner, so that the core network element may terminate the request process of the PIN policy in a timely manner.

To facilitate understanding of the method performed by the AMF 103 in the embodiments of the disclosure, the following embodiment describes an implementation that the AMF 103 interacts the PIN policy request indication with the UE 101 via the RAN 102.

An embodiment of the disclosure provides a communication method, which is performed by the AMF 103. Referring to FIG. 6, it is a flowchart illustrating a communication method according to an embodiment. The method shown in FIG. 6 is performed by the AMF 103. As shown in FIG. 6, the method includes the following steps S601 to S603.

At S601, an AMF 103 receives a registration request sent by a UE 101 via an access network device 102, in which the registration request includes a PIN policy request indication for requesting a PIN policy.

In some possible implementations, referring to the implementation of step S301 or S401, the AMF 103 communicates with the UE 101 via the accessing network device 102.

In some possible implementations, the registration request includes a UE policy container including the PIN policy request indication.

At S602, the AMF 103 sends the PIN policy request indication to the PCF 109, and receives PIN policy information sent by the PCF 109.

In some possible implementations, after receiving the UE policy container containing the PIN policy request indication, the AMF 103 may send the UE policy container containing the PIN policy request indication to the PCF, which thus implements sending the PIN policy request indication.

In some possible implementations, the AMF 103 receives the PIN policy information from the PCF 109. For example, the AMF 103 may also receive a UE policy container including the PIN policy information.

At S603, the AMF 103 sends the PIN policy information to the UE 101 via the access network device 102.

In some possible implementations, the AMF 103 transfers transparently the received UE policy container including the PIN policy information to the UE 101.

In some possible implementations, the PIN policy information includes at least one of: a PIN ID, a configuration of a PEGC, or routing information.

In the embodiment of the disclosure, after receiving the registration request from the UE 101, the AMF 103 may send the PIN policy request indication sent by the UE 101 to the PCF 109, and forward the PIN policy information received from the PCF 109 to the UE 101, so as to meet communication needs of the UE 101 in the PIN scenarios.

An embodiment of the disclosure provides a communication method, which is performed by the AMF 103. The method includes the following steps S601 to S603.

At S601, an AMF 103 receives a registration request sent by a UE 101 via an access network device 102, in which the registration request includes a PIN policy request indication for requesting a PIN policy.

At S602, the AMF 103 sends the PIN policy request indication to the PCF 109, and receives PIN policy information sent by the PCF 109.

In this implementation, sending by the AMF 103, the PIN policy request indication to the PCF 109 at S602 may include the following step S602-1, for example.

At S602-1, the AMF 103 sends a create request for UE policy control to the PCF 109, in which the create request includes a UE policy container including the PIN policy request indication.

In some possible implementations, after receiving the UE policy container containing the PIN policy request indication from the RAN 102, the AMF 103 may determine to perform UE policy association establishment and send the create request to the PCF 109.

In some possible implementations, the create request sent by the AMF 103 adopts Npcf_UEPolicyControl Create Request, for example. The create request includes the UE policy container including the PIN policy request indication received from the UE 101.

In some possible implementations, the UE policy association establishment is used to associate the UE 101 with its related PIN policy information.

In an example, receiving the PIN policy information sent by the PCF 109 at S602 may include the following step S602-2, for example.

At S602-2, the AMF 103 receives the UE policy container sent by the PCF 109, in which the UE policy container includes the PIN policy information.

At S603, the AMF 103 sends the PIN policy information to the UE 101 via the access network device 102.

It may be understood that the implementation of the above steps S601 and S603 may refer to the description of the above embodiments, which will not be repeated here.

In the embodiment of the disclosure, after receiving the UE policy container including the PIN policy request indication, the AMF 103 may send the create request to the PCF 109 to perform the UE policy association establishment, which is beneficial to associating the UE 101 with its related PIN policy information, so as to obtain the accurate PIN policy information requested by the UE 101.

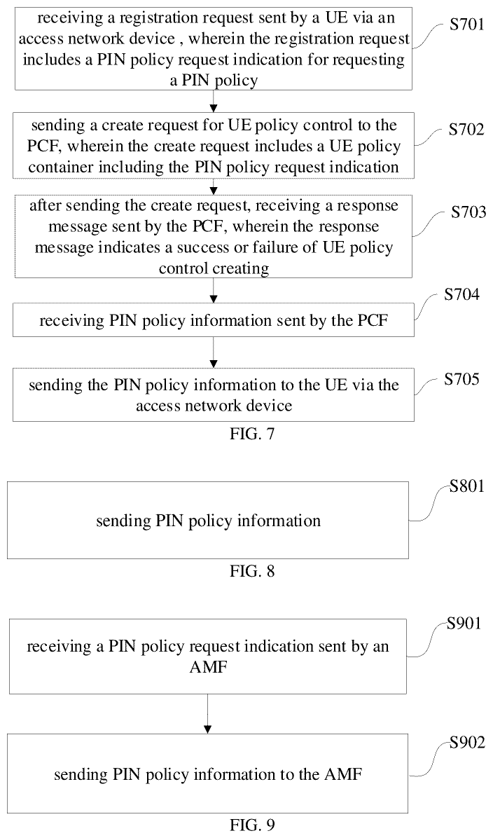

An embodiment of the disclosure provides a communication method, which is performed by the AMF 103. Referring to FIG. 7, it is a flowchart illustrating a communication method according to an embodiment. The method shown in FIG. 7 is performed by the AMF 103. As shown in FIG. 7, the method includes the following steps S701 to S705.

At S701, an AMF 103 receives a registration request sent by a UE 101 via an access network device 102, in which the registration request includes a PIN policy request indication for requesting a PIN policy.

The implementation of the above step S701 may refer to the implementation of the above step S601, which will not be repeated here.

At S702, the AMF 103 sends a create request for UE policy control to the PCF 109, in which the create request includes a UE policy container including the PIN policy request indication.

The implementation of the above step S702 may refer to the implementation of the above step S602-1, which will not be repeated here.

At S703, after sending the create request, the AMF 103 receives a response message sent by the PCF 109, in which the response message indicates a success or failure of UE policy control creating.

In some possible implementations, the AMF 103 sends the create request to request the PCF 109 to perform UE policy association establishment. The AMF 103 receives the response information from the PCF 109 according to the create request. The response information may indicate whether UE policy control creating is successful or fails, that is, whether UE policy association establishment is successful or fails.

In an example, the response message received by the AMF 103 is, for example, Npcf_UEPolicyControl Create Response.

In an example, when the UE policy association establishment is successful, a UE policy association ID may be included in the response message to index the associated PIN policy information.

At S704, the AMF 103 receives the PIN policy information sent by the PCF 109

The implementation of the above step S704 may refer to the implementation of the above steps S602 or S602-2, which will not be repeated here.

At S705, the AMF 103 sends the PIN policy information to the UE 101 via the access network device 102.

The implementation of the above step S705 may refer to the implementation of the above step S603, which will not be repeated here.

In the embodiment of the disclosure, after initiating the create request, the AMF 103 may receive the response message sent by the PCF 109, which thus knows whether the UE policy association establishment is successful. The obtained response message may also include a UE policy association ID, so that the UE 101 may be indexed to correct and appropriate PIN policy information according to the UE policy association ID.

An embodiment of the disclosure provides a communication method, which is performed by the AMF 103. The method includes the following steps S701-S703, S703′, S704-S705.

At S701, an AMF 103 receives a registration request sent by a UE 101 via an access network device 102, in which the registration request includes a PIN policy request indication for requesting a PIN policy.

The implementation of the above step S701 may refer to the implementation of the above step S601, which will not be repeated here.

At S702, the AMF 103 sends a create request for UE policy control to the PCF 109, in which the create request includes a UE policy container including the PIN policy request indication.

The implementation of the above step S702 may refer to the implementation of the above step S602-1, which will not be repeated here.

At S703, after sending the create request, the AMF 103 receives a response message sent by the PCF 109, in which the response message indicates a success or failure of UE policy control creating.

The implementation of the above step S703 may refer to the description of the embodiment corresponding to FIG. 6, which will not be repeated here.

At S703′, the AMF 103 sends a registration accept message to the UE 101.

For example, the AMF 103 sends the registration accept message to the UE 101 via the access network device 102.

The order of steps S703 and S703′ is for illustration only without limitations. The AMF 103 may also execute the step S703′ first. Alternatively, at S703, when the UE policy control establishment fails, the AMF 103 may also execute the step S703′.

In some possible implementations, the registration reception message indicates that the UE 101 has successfully registered with the network.

In some possible implementations, the AMF 103 may receive a UE policy container including the PIN policy information after sending the registration accept message.

At S704, the AMF 103 receives the PIN policy information sent by the PCF 109

The implementation of the above step S704 may refer to the implementation of the above step S602 or S602-2, which will not be repeated here.

At S705, the AMF 103 sends the PIN policy information to the UE 101 via the access network device 102.

The implementation of the above step S705 may refer to the implementation of the above step S603, which will not be repeated here.

In some possible implementations, the method may further include the following steps S706 and S707.

At S706, the AMF 103 receives a notification message sent by the UE 101 via the access network device 102, in which the notification message indicates that the PIN policy information in the UE 101 has been updated.

The implementation of the above step S706 may refer to the implementation of the above step S404, which will not be repeated here.

At S707, the AMF 103 sends the notification message to the PCF 109.

In some possible implementations, the AMF 103 may adopt Namf_Communication_N1MessageNotify to send the notification message to the PCF 109.

It may be understood that this implementation is a preferred example provided by the embodiments of the disclosure, but it is not limited to including all the above steps. For example, in the embodiment corresponding to FIG. 4, the method may also include the above steps S601 to S603 and the above steps S706 to S707.

In the embodiment of the disclosure, the information transmission role of the AMF 103 in the entire process of UE 101 requesting the PIN policy is preferably illustrated. On this basis, sending the PIN policy information is realized, and it is beneficial for the UE 101 to perform the PIN-related procedures or communications.

An embodiment of the disclosure provides a communication method, which is performed by the PCF 109. Referring to FIG. 8, it is a flowchart illustrating a communication method according to an embodiment. The method shown in FIG. 8 is performed by a PCF 109. As shown in FIG. 8, the method includes the following step S801.

At S801, the PCF 109 sends PIN policy information.

In some possible implementations, the PIN policy information may be preconfigured in the PCF 109.

In some possible implementations, the PCF 109 may actively send the PIN policy information. For example, the PCF 109 sends the PIN policy information to the UE 101 via the AMF 103.

In the embodiment of the disclosure, the PCF 109 may support, by sending the PIN policy information, a device required to perform PIN-related procedures after receiving the PIN policy information.

An embodiment of the disclosure provides a communication method, which is performed by the PCF 109. The method includes the following steps S801-1 to S801-2.

At S801-1, the PCF 109 receives a PIN policy request indication.

In some possible implementations, the PCF 109 may receive the PIN policy request indication forwarded by the AMF 103.

For example, the step is that the PCF 109 receives the PIN policy request indication sent by the AMF 103.

Alternatively, the step is that the PCF 109 receives the PIN policy request indication sent by the UE 101 via the AMF 103.

In some possible implementations, the PCF 109 receives the PIN policy request indication, which may be receiving a message or a policy container that carries the PIN policy request indication.

In an example, the step S801-1 may include the following step S801-1′, for example.

At S801-1′, the PCF 109 receives a create request, which includes a PIN policy request indication.

In this example, the PCF 109 may receive the create request sent by the AMF 103, in which the create request carries the PIN policy request indication received by the AMF 103 from the UE 101.

In another example, the create request includes a first UE policy container including the PIN policy request indication. For example, the PCF 109 receives the create request sent by the AMF 103, in which the create request includes the first UE policy container received by the AMF 103 from the UE 101.

In some possible implementations, after the above step S801-1′, the method further includes the following step S801-1″, for example.

At S801-1″, after receiving the create request, the PCF 109 sends a response message to the AMF 103, in which the response message indicates a success or failure of UE policy control creating.

In this implementation, the response information may indicate whether UE policy control creating is successful or fails, that is, whether UE policy association establishment is successful or fails. When the UE policy association establishment is successful, a UE policy association ID may be included in the response message to index the associated PIN policy information.

At S801-2, the PCF 109 sends the PIN policy information.

In some possible implementations, the above step S801-2 may include the following step that the PCF 109 sends the PIN policy information to the AMF 103. In this implementation, the AMF 103 may either process the received message or directly forward the received message to the UE 101.

Alternatively, the above step S801-2 may include the following step that the PCF 109 sends the PIN policy information to the UE 101 via the AMF 103. In this implementation, the AMF 103 may forward the PIN policy information to the UE 101 via the RAN 102 without processing the message.

In some possible implementations, the PCF 109 may send the PIN policy information in the following step: sending a second UE policy container, in which the second UE policy container includes the PIN policy information.

For example, the PCF 109 sends the second UE policy container to the AMF 103, and the AMF 103 transfers transparently the received second UE policy container to the UE 101.

An embodiment of the disclosure provides a communication method, which is performed by a PCF 109. The method includes the following steps S801 to S802.

At S801, the PCF 109 sends PIN policy information.

At S802, the PCF 109 receives a notification message sent by the UE 101 via an AMF 103, in which the notification message indicates that the UE 101 has received the PIN policy information.

The implementation of steps S801 to S802 in the embodiments of the disclosure may also refer to the above description of the corresponding embodiments in FIG. 2 to FIG. 7, which will not be repeated here.

To facilitate understanding of the method performed by the PCF 109 in the embodiment of the disclosure, the following embodiment describes an implementation that the PCF 109 receives the PIN policy request indication and sends the PIN policy information to the UE 101 via the AMF 103 and the RAN 102.

An embodiment of the disclosure provides a communication method, which is performed by a PCF 109. Referring to FIG. 9, it is a flowchart illustrating a communication method according to an embodiment. The method shown in FIG. 9 is performed by a PCF 109. As shown in FIG. 9, the method includes the following steps S901 to S902.

At S901, a PCF 109 receives a PIN policy request indication sent by an AMF 103.

In some possible implementations, the AMF 103 may send the PIN policy request indication to the PCF 109 after receiving a registration request from the UE 101

In some possible implementations, the above step S901 may include the following step S901′, for example.

At S901′, the PCF 109 receives a create request for UE policy control sent by the AMF 103, in which the create request includes: a UE policy container including the PIN policy request indication.

The implementation of the above step S901′ may refer to the implementation of the above step S602-1, which will not be repeated here.

At S902, the PCF 109 sends PIN policy information to the AMF 103.

In some possible implementations, the PCF 109 may be pre-configured with the PIN policy information.

In some possible implementations, after receiving the PIN policy request indication, the PCF 109 sends the PIN policy information to the UE 101 via the AMF 103 and the RAN 102.

In some possible implementations, the PIN policy information includes at least one of: a PIN ID, a configuration of a PEGC, or routing information.

In the embodiment of the disclosure, after receiving the PIN policy request indication forwarded by the AMF 103, the PCF 109 may send the PIN policy information to the UE 101 via the AMF 103, so as to meet communication needs of the UE 101 in the PIN scenarios.

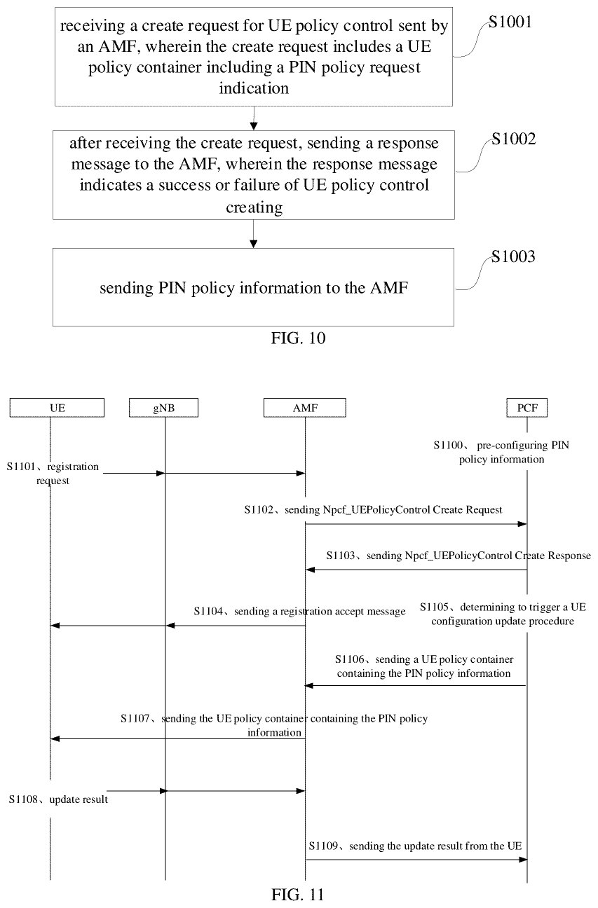

An embodiment of the disclosure provides a communication method, which is performed by a PCF 109. Referring to FIG. 10, it is a flowchart illustrating a communication method according to an embodiment. The method shown in FIG. 10 is performed by the PCF 109. As shown in FIG. 10, the method includes the following steps S1001 to S1003.

At S1001, a PCF 109 receives a create request for UE policy control sent by an AMF 103, in which the create request includes a UE policy container including a PIN policy request indication.

The description of the above step S1001 may refer to the implementation of the above step S901′, which will not be repeated here.

At S1002, after receiving the create request, the PCF 109 sends a response message to the AMF 103, in which the response message indicates a success or failure of UE policy control creating.

The description of the above step S1002 may refer to the implementation of the above step 703 in the above embodiment, which is not fully repeated here.

In some possible implementations, after receiving the create request, the PCF 109 generates a UE Policy Association ID to index the associated PIN policy information.

In some possible implementations, the PCF 109 may send the response message via Npcf_UEPolicyControl Create Response.

In an example, the response message includes a UE policy association ID.

At S1003, the PCF 109 sends PIN policy information to the AMF 103.

The implementation of the above step S1003 may refer to the implementation of the above step S902, which is not fully repeated here.

In some possible implementations, the above step S1003 may also include the following step S1003′, for example.

At S1003′, the PCF 109 sends a UE policy container to the AMF 103, in which the UE policy container includes the PIN policy information.

In this implementation, the PCF 109 may call Namf_Communication_N1N2 Message Transfer of the AMF to send the UE policy container including the PIN policy information.

In some possible implementations, the Namf_Communication_N1N2 MessageTransfer may also include a subscription permanent identifier (SUPI), that is, the PCF 109 sends the SUPI together with the UE policy container including the PIN policy information to the AMF 103.

In some possible implementations, after receiving the create request, the PCF 109 may also determine whether to trigger a UE configuration update procedure.

For example, after the PCF 109 triggers the configuration update procedure, the PCF 109 sends the UE policy container containing the PIN policy information to the AMF 103, and the AMF 103 transfers transparently the UE policy container containing the PIN policy information to the UE 101 via the RAN 102.

In some possible implementations, in the configuration update procedure, the method may further include the following step S1004, for example.

At S1004, the PCF 109 receives a notification message sent by the AMF 103, in which the notification message indicates that the PIN policy information in the UE 101 has been updated.

In some possible implementations, the AMF 103 may use Namf_Communication_N1MessageNotify to send the notification message to the PCF 109.

In the embodiment of the disclosure, after receiving the UE policy container containing the PIN policy request indication sent by the AMF 103, the PCF 109 may trigger the configuration update procedure and send the pre-configured PIN policy information to the UE 101 via the AMF 103, which facilitates the UE 101 to perform PIN-related procedures and communications according to the PIN policy information.

An embodiment of the disclosure provides a communication method, which is performed by a core network device. The core network device may include at least an AMF 103 and a PCF 109. The method may include the following steps S100-1 to S100-3.

At S100-1, PIN policy information is pre-configured.

At S100-2, a PIN policy request indication sent by a UE 101 is received.

At S100-3, the PIN policy information is sent to the UE 101.

For the description of the embodiments of the disclosure, reference may be made to the description of the corresponding embodiments in FIG. 2 to FIG. 10, which will not be repeated here.

To facilitate understanding of the embodiments of the disclosure, some specific examples are listed below. Referring to FIG. 11, the method of this example may include one, some or all of the following steps S1100 to S1109.

At S1100, PIN policy information is pre-configured in the PCF 109.

At S1101, the UE sends a registration request to the AMF via the gNB, and a PIN policy request indication is included in a UE policy container.

At S1102, when the AMF receives the UE policy container from the UE, the AMF determines and sends an Npcf_UEPolicyControl Create Request to the PCF for UE policy association establishment. The request includes the UE policy container including the PIN policy request indication.

At S1103, the PCF sends Npcf_UEPolicyControl Create Response to the AMF, indicating whether the UE policy association is successful or fails. The response may include a UE Policy Association ID.

At S1104, the AMF sends a registration accept message to the UE via the gNB.

At S1105, when the PCF receives the PIN policy request indication from the AMF, the PCF decides to trigger a UE configuration update procedure to send the PIN policy information to the UE.

At S1106, the PCF calls a Namf_Communication_N1N2 MessageTransfer service operation provided by the AMF, and sends a SUPI and a UE policy container containing the PIN policy information.

The PIN policy information includes a PIN ID, PEGC configuration, routing information, etc.

At S1107, the AMF transfers transparently the UE policy container (including the PIN policy information) received from the PCF to the UE.

At S1108, the UE updates a UE policy (i.e., PIN policy information) provided by the PCF and sends an update result to the AMF.

At S1109, the AMF uses Namf_Communication_N1MessageNotify to forward the update result of the UE to the PCF.

The steps S1106 to S1109 belong to the configuration update procedure.

The implementations of each step in this example may refer to the description of the related steps in the previous embodiments, which will not be repeated here.

The above steps are for clearly illustrating the flowcharts of the embodiments of the disclosure. In some implementations, some of the steps may be performed, or the steps may be performed in an order different from that illustrated above.

For example, the above steps S1108 and S1109 are optional, such as not performing the above steps S1108 and S1109. For example, the above steps S1101 to S1107 may be executed. In addition, this embodiment does not limit the execution order. For example, the above step S1100 only needs to be executed before the above step S1106.

In the embodiment of the disclosure, the UE sends a new PIN policy request indication in the UE policy container to the PCF via the AMF. After receiving the PIN policy request indication, the PCF may decide to trigger the UE configuration update procedure and send the PIN policy information to the UE, which enables the UE 101 to request the PIN policy information from the core network and to implement related PIN procedures or communications.

The above implementations or embodiments are not exhaustive and are merely illustrations of some implementations or embodiments, and are not intended to be specific limitations on the protection scope of the embodiments of the disclosure. In the absence of contradiction, each step in a certain implementation or example may be implemented as an independent example, and the steps may be arbitrarily combined. For example, a solution after removing some steps in a certain implementation or example may also be implemented as an independent example, and the order of the steps in a certain implementation or example may be arbitrarily exchanged. In addition, optional methods or examples in a certain implementation or example may be arbitrarily combined. In addition, various implementations or examples may be arbitrarily combined. For example, some or all steps in different implementations or examples may be arbitrarily combined, and a certain implementation or example may be arbitrarily combined with the optional methods or examples in other implementations or examples.

In the disclosure, “including A” and “indicating A” may mean directly including or carrying A, or may mean indirectly indicating A without necessarily carrying A, depending on the situations. In the disclosure, “in response to . . . ” , “in the case of/that . . . ”, “while . . . ” , “when/upon . . . ”, “if . . . ” , “in case of/that . . . ”, etc. may be replaced with each other depending on the situations. In addition, regarding the expressions in the disclosure such as “A or B”, “A and/or B”, “at least one of A or B”, “A in one case, B in another case”, “in response to one case A, in response to another case B”, etc., at least one of following schemes may be included according to the situations: executing A independently of B, i.e., A in some embodiments; executing B independently of A, i.e., B in some embodiments; selectively executing A or B, i.e., one is selected from A and B for execution in some embodiments; executing both A and B, i.e., A and B in some embodiments. In addition, each element, each row, or each column in the tables involved in the disclosure may be implemented as an independent embodiment, and a combination of any element, any row, and any column may also be implemented as an independent embodiment.

Based on the same concept as the above method embodiments, an embodiment of the disclosure also provides a first communication apparatus, which may have the functions of the UE 101 in the above method embodiments and may be used to execute the steps performed by the UE 101 according to the above method embodiments. The functions may be implemented in hardware, software, or hardware executing corresponding software. The hardware or software includes one or more modules corresponding to the above functions.

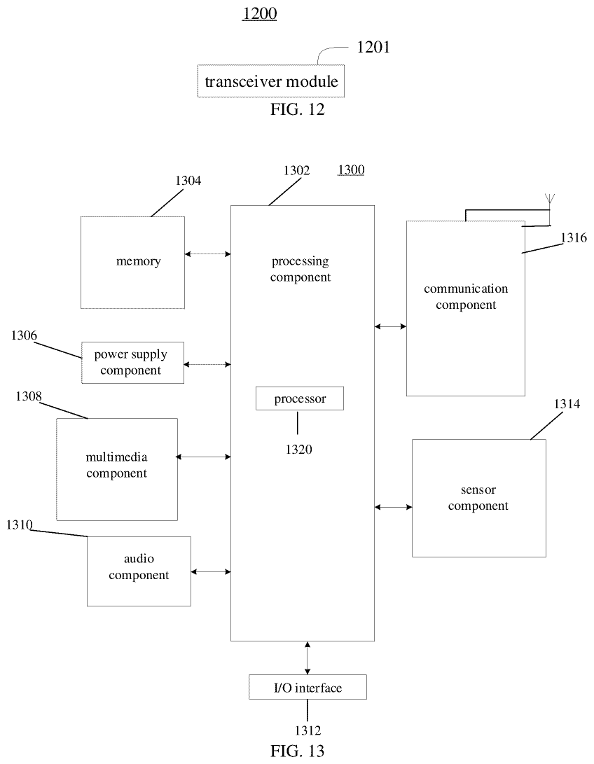

In a possible implementation, the apparatus 1200 shown in FIG. 12 may serve as the UE 101 involved in the above method embodiments, and execute the steps performed by the UE 101 in the above method embodiments. As shown in FIG. 12, the apparatus 1200 may include a transceiver module 1201 that may be used to support the communication apparatus to perform communication.

When executing the steps implemented by the UE 101, the transceiver module 1201 is configured to receive PIN policy information.

When the communication device is the UE 101, its structure may also be as shown in FIG. 13. The device 1300 may be a mobile phone, a computer, a digital broadcast terminal, a messaging device, a game console, a tablet device, a medical device, a fitness device, a personal digital assistant, etc.

Referring to FIG. 13, the device 1300 may include one or more of the following components: a processing component 1302, a memory 1304, a power supply component 1306, a multimedia component 1308, an audio component 1310, an inputs/outputs interface (I/O) 1312, a sensor component 1314, and a communication component 1316.

The processing component 1302 generally controls the overall operation of the device 1300, such as operations associated with displays, telephone calls, data communications, camera operations, and operations associated with recording operations. The processing component 1302 may include one or more processors 1320 to execute instructions to accomplish all or some of the steps of the method described above. Alternatively, the processing component 1302 may include one or more modules to facilitate interaction between the processing component 1302 and other components. For example, the processing component 1302 may include a multimedia module to facilitate interaction between the multimedia component 1308 and the processing component 1302.

The memory 1304 is configured to store various types of data to support operation at the device 1300. Examples of such data include instructions for any application program or method operated on the device 1300, contact data, phone book data, messages, pictures, videos, etc. The memory 1304 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or CD-ROM.

The power supply component 1306 provides power to the various components of the device 1300. The power supply component 1306 may include a power management system, one or more power supplies, and other components associated with generating, managing, and distributing power for the device 1300.

The multimedia component 1308 includes a screen providing an output interface between the device 1300 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also detect a duration and a pressure associated with the touch or swipe operation. In some embodiments, the multimedia component 1308 includes a front-facing camera and/or a rear-facing camera. The front camera and/or the rear camera may receive external multimedia data when the device 1300 is in an operating mode, such as a shooting mode or a video mode. Each of the front camera and the rear camera may be a fixed optical lens system or have a focal length and optical zoom capability.

The audio component 1310 is configured to output and/or input audio signals. For example, the audio component 1310 includes a microphone (MIC) that is configured to receive external audio signals when the device 1300 is in an operational mode, such as a call mode, a recording mode, and a voice recognition mode. The received audio signals may be further stored in the memory 1304 or sent via the communication component 1316. In some embodiments, the audio component 1310 further includes a speaker for outputting audio signals.

The I/O interface 1312 provides an interface between the processing component 1302 and a peripheral interface module, said peripheral interface module may be a keypad, a click wheel, buttons, etc. These buttons may include, but are not limited to: a home button, a volume button, a start button, and a lock button.

The sensor component 1314 includes one or more sensors for providing various aspects of status assessment for the device 1300. For example, the sensor component 1314 may detect an open/closed state of the device 1300, the relative positioning of components, such as the display and keypad of the device 1300, the sensor component 1314 may also detect a change in the position of the device 1300 or one of the components of the device 1300, the presence or absence of user contact with the device 1300, the orientation of the device 1300 or acceleration/deceleration of the device 1300, and the temperature change of the device 1300. The sensor component 1314 may include a proximity sensor configured to detect the presence of a nearby object in the absence of any physical contact. The sensor component 1314 may also include an optical sensor, such as a CMOS or CCD image sensor, for use in imaging applications. In some embodiments, the sensor component 1314 may also include an acceleration sensor, a gyroscope sensor, a magnetic sensor, a pressure sensor, or a temperature sensor.

The communication component 1316 is configured to facilitate communication between the device 1300 and other devices by wired or wireless means. The device 1300 may access a wireless network based on a communication standard, such as Wi-Fi, 2G or 3G, or their combination. In an embodiment, the communication component 416 receives broadcast signals or broadcast-related information from an external broadcast management system in a broadcast channel. In an embodiment, the communication component 1316 further includes a near field communication (NFC) module to facilitate short-range communication. For example, in the NFC module may be implemented based on radio frequency identification (RFID) technology, infrared data association (IrDA) technology, ultra wide band (UWB) technology, Bluetooth (BT) technology, and other technologies.

In embodiments, the device 1300 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the methods described above.

In embodiments, there is also provided a non-transitory computer-readable storage medium including instructions, such as a memory 1304 including instructions, the instructions being executable by a processor 1320 of the device 1300 for accomplishing the above-described method. For example, the non-transitory computer-readable storage medium may be an ROM, a random access memory (RAM), a CD-ROM, a magnetic tape, a floppy disks, and optical data storage devices, etc.

Based on the same concept as the above method embodiments, an embodiment of the disclosure also provides a third communication apparatus, which may have the functions of the AMF 103 in the above method embodiments and may be used to execute the steps performed by the AMF 103 according to the above method embodiments. The functions may be implemented in hardware, software, or hardware executing corresponding software. The hardware or software includes one or more modules corresponding to the above functions.

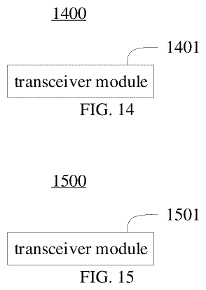

In a possible implementation, the apparatus 1400 shown in FIG. 14 may serve as the AMF 103 involved in the above method embodiments, and execute the steps performed by the AMF 103 in the above method embodiments. As shown in FIG. 14, the apparatus 1400 may include a transceiver module 1401 that may be used to support the communication apparatus to perform communication.

When executing the steps implemented by the AMF 103, the transceiver module 1401 is configured to receive PIN policy information sent by a PCF.

The transceiver module 1401 is further configured to send the PIN policy information to a UE.

In a possible implementation, the apparatus 1400 includes a processor and a memory. The memory is used to store a computer program, and the processor is used to execute the computer program to implement the steps performed by the AMF 103.

In a possible implementation, an embodiment also provides a computer-readable storage medium storing instructions (or computer programs, programs), which, when called and executed on a computer, enable the computer to execute the steps performed by the above AMF 103.

Based on the same concept as the above method embodiments, an embodiment of the disclosure also provides a second communication apparatus, which may have the functions of the PCF 109 in the above method embodiments and may be used to execute the steps performed by the PCF 109 according to the above method embodiments. The functions may be implemented in hardware, software, or hardware executing corresponding software. The hardware or software includes one or more modules corresponding to the above functions.

In a possible implementation, the apparatus 1500 shown in FIG. 15 may serve as the PCF 109 involved in the above method embodiments, and execute the steps performed by the PCF 109 in the above method embodiments. As shown in FIG. 15, the apparatus 1500 may include a transceiver module 1501 that may be used to support the communication apparatus to perform communication.

When executing the steps implemented by the PCF 109, the transceiver module 1501 is configured to send PIN policy information.

In a possible implementation, the apparatus 1500 includes a processor and a memory. The memory is used to store a computer program; and the processor is used to execute the computer program to implement the steps performed by the PCF 109.

In a possible implementation, an embodiment also provides a computer-readable storage medium storing stores instructions (or computer programs, programs), which, when called and executed on a computer, enable the computer to execute the steps performed by the above PCF 109.

Based on the same concept as the above method embodiments, an embodiment of the disclosure further provides a core network device, which may include a processing module and a transceiver module.

During the process of executing the above methods, the processing module is used to pre-configure PIN policy information.

The transceiver module is configured to receive a PIN policy request indication sent by the UE 101.

The transceiver module is further configured to send PIN policy information to the UE 101.

Other implementations of the embodiment of the disclosures will be apparent to those skilled in the art from consideration of the specification and practice of the invention disclosed herein. The disclosure is intended to cover any modifications, uses or adaptive changes of the embodiments of the disclosure, which follow the general principles of the embodiments of the disclosure and include common knowledge or conventional technical means in the technical field that are not disclosed in the disclosure. The specification and examples are considered as exemplary only, with a true scope of the embodiments of the disclosure being indicated by the following claims.

It should be understood that the embodiments of the disclosure are not limited to the exact structures that have been described above and shown in the drawings, and that various modifications and changes may be made without departing from the scope thereof. The scope of the embodiment of the disclosures is limited only by the appended claims.

### INDUSTRIAL APPLICABILITY

In the method of the disclosure, after obtaining PIN policy information, the UE may support necessary PIN procedures, such as performing communication between the PINEs, which thus overcomes the problem of being unable to support the necessary procedures for the PIN since the UE does not obtain the PIN-related policy information.

1. A communication method, performed by a user equipment (UE), the method comprising:
receiving personal IoT network (PIN) policy information.

2. The method according to claim 1, further comprising:
sending a PIN policy request indication.

3. The method according to claim 2, wherein sending the PIN policy request indication comprises:
sending a registration request, wherein the registration request comprises the PIN policy request indication.

4. The method according to claim 3, wherein the registration request comprises a first UE policy container comprising the PIN policy request indication.

5. The method according to claim 2, wherein sending the PIN policy request indication comprises one of:
sending the PIN policy request indication to an access and mobility management function (AMF); or
sending the PIN policy request indication to a policy and charging function (PCF) via an AMF.

6. (canceled)

7. The method according to claim 1, wherein receiving the PIN policy information comprises:
receiving a second UE policy container sent by an AMF, or sent by a PCF via the AMF,
wherein the second UE policy container comprises the PIN policy information.

8. (canceled)

9. The method according to claim 1, further comprising at least one of:
before receiving the PIN policy information, receiving a registration accept message, wherein the registration accept message indicates that the UE has successfully registered with a network; or
after receiving the PIN policy information, sending a notification message;
and/or
wherein the PIN policy information comprises at least one of: a PIN identifier; a configuration of a PIN element with gateway capability (PEGC); or routing information.

10-11. (canceled)

12. A communication method, performed by a policy and charging function (PCF), the method comprising:
sending personal IoT network (PIN) policy information.

13. The method according to claim 12, further comprising:
receiving a PIN policy request indication sent by an AMF, or sent by a UE via the AMF.

14. The method according to claim 13, wherein receiving the PIN policy request indication comprises:
receiving a create request, wherein the create request comprises the PIN policy request indication.

15. The method according to claim 14, wherein the create request comprises a first user equipment (UE) policy container comprising the PIN policy request indication.

16. The method according to claim 14, further comprising:
after receiving the create request, sending a response message to an access and mobility management function (AMF), wherein the response message indicates a success or failure of UE policy control creating.

17. (canceled)

18. The method according to claim 12, wherein sending the PIN policy information comprises one of:
sending the PIN policy information to an AMF; or
sending the PIN policy information to a UE via an AMF;
and/or
wherein sending the PIN policy information comprises: sending a second UE policy container, wherein the second UE policy container comprises the PIN policy information;
and/or
wherein the method further comprises: receiving a notification message sent by a UE via an AMF, wherein the notification message indicates that the UE has received the PIN policy information.

19-21. (canceled)

22. A communication method, performed by an access and mobility management function (AMF), the method comprising:
receiving personal IoT network (PIN) policy information sent by a policy and charging function (PCF); and
sending the PIN policy information to a user equipment (UE).

23. The method according to claim 22, wherein receiving the PIN policy information sent by the PCF comprises:
receiving a second UE policy container sent by the PCF, wherein the second UE policy container comprises the PIN policy information.

24. The method according to claim 22, further comprising:
receiving a PIN policy request indication sent by the UE; and
sending the PIN policy request indication to the PCF.

25. The method according to claim 24, wherein receiving the PIN policy request indication sent by the UE comprises:
receiving a registration request sent by the UE, wherein the registration request comprises a first UE policy container comprising the PIN policy request indication; and
wherein sending the PIN policy request indication to the PCF comprises: sending a create request to the PCF, wherein the create request comprises the PIN policy request indication.

26. (canceled)

27. The method according to claim 25, further comprising:
receiving a response message sent by the PCF, wherein the response message indicates a success or failure of UE policy control creating.

28. The method according to 22, further comprising at least one of:
sending a registration acceptance message to the UE, wherein the registration acceptance message indicates that the UE has successfully registered with a network; or
receiving a notification message sent by the UE, and sending the notification message to the PCF, wherein the notification message indicates that the UE has received the PIN policy information.

29-32. (canceled)

33. A user equipment, configured to perform the method according to claim 1.

34. (canceled)
